(19) United States
(12) Patent Application Publication
(10) Pub. No.: US 2021/0147009 A1
(43) Pub. Date: May 20, 2021

(54) REFRIGERATED TRUCK WITH SIDE DOORS

(71) Applicant: Shanghai Ocean University, Shanghai (CN)

(72) Inventors: Jing XIE, Shanghai (CN); Yuyao SUN, Shanghai (CN); Jinfeng WANG, Shanghai (CN)

(21) Appl. No.: 16/820,606

(22) Filed: Mar. 16, 2020

(30) Foreign Application Priority Data
Nov. 15, 2019 (CN) 201911115737.7

(51) Int. Cl. B62D 33/04; B60P 3/20; F24F 9/00; B60J 5/04

(52) U.S. Cl. CPC B62D 33/048; B60P 3/205; F24F 9/00; F24F 2009/005; B60J 5/0488; B60J 5/0497; B60J 5/0483

(57) ABSTRACT

The present invention relates to refrigerated trucks, more particularly to a refrigerated truck with side doors, including a refrigerated compartment, a chiller, a partition plate, glass plates, top plates, rotating shafts, side doors, support plates, air curtains, floors, base plates, slots, recessed handles, rails, moveable windows, moving handles and grooves. In the refrigerated truck with side doors of the present invention, doors are arranged on both sides of the refrigerated compartment, and the air curtains are used, which effectively reduces the amount of cold air loss and hot air intrusion, thereby reducing energy consumption of the chiller. Moreover, the support plates are configured to play an auxiliary role in both bearing load and keeping the balance. The present invention makes a contribution to energy saving of the refrigerated truck.

### CROSS-REFERENCE TO RELATED APPLICATIONS

This application claims the benefit of priority from Chinese Patent Application No. 201911115737.7, filed on Nov. 15, 2019. The content of the aforementioned application, including any intervening amendments thereto, is incorporated herein by reference in its entirety.

### TECHNICAL FIELD

The present application relates to refrigerated trucks, more particularly to a refrigerated truck with side doors.

### BACKGROUND OF THE INVENTION

Refrigerated trucks are used for storing and transporting frozen food. During the transportation, the air in refrigerated trucks is kept at a low temperature, which can ensure the good quality of frozen food. However, when a door or doors of the refrigerated truck are opened, internal cold air will escape and external hot air will enter the refrigerated compartment of the refrigerated truck, thereby increasing energy consumption of the chiller. Since the frozen food is often transported from one place to another, the side doors of the refrigerated compartment will be frequently opened. Therefore, attention should be paid on how to ensure less cold air loss and hot air intrusion in the refrigerated compartment when the doors of the refrigerated compartment are opened. If this problem can be solved, the energy consumption of chillers will be reduced and the quality of frozen food will be better.

### SUMMARY OF THE INVENTION

The purpose of the present invention is to provide a refrigerated truck with side doors, in which the side doors with an opening angle of less than 30° are installed on both sides of the refrigerated compartment, and air curtains are installed on the side doors to generate air stream. Therefore, the refrigerated truck disclosed by the invention reduces the possibility of cold air loss and hot air intrusion in the refrigerated compartment, thereby reducing energy consumption of chillers.

To achieve the purpose above, the disclosure provides a refrigerated truck with side doors, comprising: a refrigerated compartment, a chiller, a partition plate, a plurality of glass plates, a plurality of top plates, a plurality of rotating shafts, a plurality of side doors, a plurality of support plates, a plurality of air curtains, a plurality of floors, a plurality of base plates, a plurality of slots, a plurality of recessed handles, a plurality of rails, a plurality of moveable windows, a plurality of moving handles and a plurality of grooves;

wherein the plurality of glass plates comprise a first glass plate and a second glass plate; the plurality of top plates comprise a first top plate, a second top plate, a third top plate, and a fourth top plate; the plurality of rotating shafts comprise a first rotating shaft, a second rotating shaft, a third rotating shaft, and a fourth rotating shaft; the plurality of side doors comprise a first side door, a second side door, a third side door, and a fourth side door;

the plurality of support plates comprise a first support plate, a second support plate, a third support plate, and a fourth support plate; the plurality of air curtains comprise a first air curtain, a second curtain machine, a third air curtain, and a fourth air curtain; the plurality of floors comprise a first floor, a second floor, a third floor, and a fourth floor; the plurality of base plates comprise a first base plate, a second base plate, a third base plate, and a fourth base plate; the plurality of slots comprise a first slot, a second slot, a third slot, and a fourth slot; the plurality of recessed handles comprise a first recessed handle, a second recessed handle, a third recessed handle, and a fourth recessed handle; the plurality of rails comprise a first rail, a second rail, a third rail, a fourth rail, a fifth rail, a sixth rail, a seventh rail, and an eighth rail; the plurality of moveable windows comprise a first moveable window and a second moveable window; the plurality of moving handles comprise a first moving handle and a second moving handle; the plurality of grooves comprise a first groove and a second groove;

the first rotating shaft, the first side door, the first support plate, the first recessed handle, the first rail, and the second rail form a first side door assembly; the second rotating shaft, the second side door, the second support plate, the second recessed handle, the third rail, and the fourth rail form a second side door assembly; the third rotating shaft, the third side door, the third support plate, the third recessed handle, the fifth rail, and the sixth rail form a third side door assembly; the fourth rotating shaft, the fourth side door, the fourth support plate, the fourth recessed handle, the seventh rail, and the eighth rail form a fourth side door assembly;

the chiller is installed at a middle of a top of a front side of the refrigerated compartment; the refrigerated compartment is divided into 4 cold storage areas of the same size by the partition plate, the first glass plate and the second glass plate; the side doors are installed on both sides of the refrigerated compartment; the top plates and the base plates are fan-shaped and connected to the side doors; the top plates are installed on a top of each of the side doors, and the base plates are respectively installed on a bottom of each of the side doors; the air curtains are installed on a middle of the top plates, respectively; the side doors and the refrigerated compartment are connected by the rotating shafts; the support plates are installed outside the side doors, and slide up and down through the rails which are installed outside the side doors; when in use, the support plates slide down to support the side doors; when not in use, the support plates slide up and is retracted; the recessed handles are installed on the support plates; when the support plates are retracted, the recessed handles assist the opening and closing of the side doors; when the support plates are used to support the side doors, the recessed handles assist the sliding of the support plates; the slots are installed in the floors of the refrigerated compartment for the arrangement of the base plates when the side doors are closed; the moveable windows are installed on the partition plates; the grooves are arranged beside the moveable windows; the moving handles are installed on the moveable windows to control the movement of the moveable windows.

Preferably, no door is provided at a rear side of the refrigerator compartment.

Preferably, the partition plate, the moveable windows and the moving handles are made of aluminum alloy.

Preferably, the side doors, the top plates and the support plates are made of rustproof aluminum alloy.

Optionally, a maximum opening angle of the side doors is 25°˜30°.

Optionally, a height of each of the support plates is 70%˜90% of a height of each of the side doors.

Preferably, the base plates are made of Q235 steel.

Preferably, a magnet is installed on a top of each of the rails, and a side of the magnet facing the support plates is N-pole.

Preferably, a magnet is installed at a top of each of the support plates, and a side of the elongate magnet facing the rails is S-pole; and the magnet is embedded in the support plate and has the same width as the support plate.

The invention provides a refrigerated truck, in which the side doors are installed on both sides of the refrigerated compartment; the maximum opening angles of the side doors are limited, and the air curtains are installed to generate air streams, so that the amount of cold air loss and hot air intrusion are effectively reduced, thereby reducing the energy consumption of the chiller. Moreover, the support plates are installed on side doors, which can play an auxiliary role in bearing load and keeping the balance. The present invention makes a contribution to energy saving and novel structures of the refrigerated truck.

### BRIEF DESCRIPTION OF THE DRAWINGS

FIG. 1A is a top view of a refrigerated truck with side doors of the present invention, in which side doors thereof are closed; FIG. 1B is a top view of the refrigerated truck with side doors of the present invention, in which the side doors thereof are open; and FIG. 1C is a schematic diagram of a first glass plate of the refrigerated truck.

FIG. 2A is a sectional view of the refrigerated truck viewed from a front side; and FIG. 2B is a sectional view of the refrigerated truck viewed from a rear side.

FIG. 3A is a left view of the refrigerated truck, in which first and second side doors are open, and third and fourth side doors are closed; and FIG. 3B is a left view of the refrigerated truck, in which first and second side doors are closed, and third and fourth side doors are open.

FIG. 4A is a schematic diagram of a first side door assembly of the refrigerated truck; FIG. 4B is a schematic diagram of a second side door assembly of the refrigerated truck; FIG. 4C is a schematic diagram of a third side door assembly of the refrigerated truck; and FIG. 4D is a schematic diagram of a fourth side door assembly of the refrigerated truck.

FIG. 5 is a schematic diagram of a partition plate of the refrigerated truck of the present invention.

### DETAILED DESCRIPTION OF EMBODIMENTS

The embodiments of the present invention will be described below in detail with reference to the accompanying drawings.

A large-sized refrigerated truck with a front-installed external cold air introduction system of the present invention is designed based on a Dongfeng Tianmian large-sized refrigerated truck. The size of the refrigerated truck is 9995×2530×3900 mm; the compartment size is 7400×2300×2400 mm; and the compartment has a wall thickness of 80 mm.

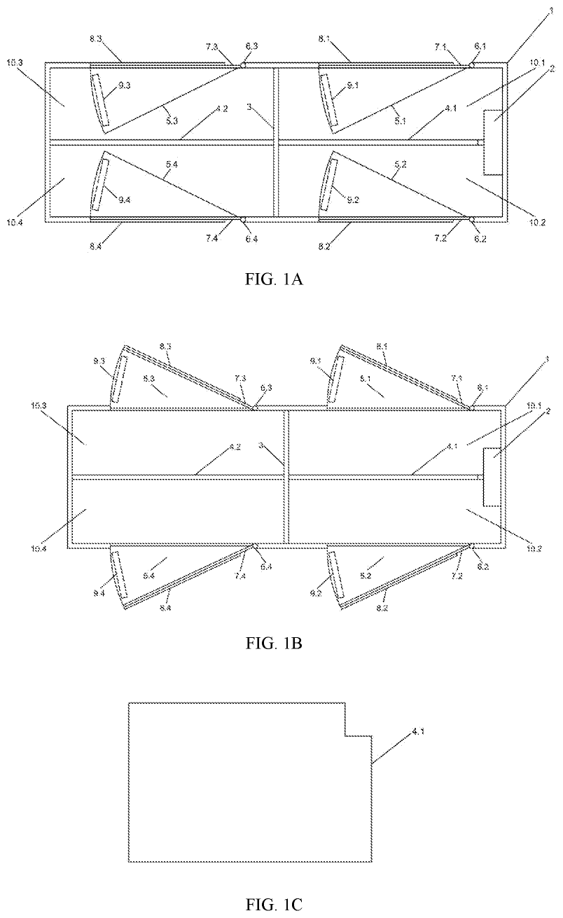

This embodiment illustrates a refrigerated truck with side doors. FIGS. 1A-1B are top views of the refrigerated truck with side doors of the present invention. The refrigerated truck includes a refrigerated compartment 1, a chiller 2, a partition plate 3, a first glass plate 4.1, a second glass plate 4.2, a first top plate 5.1, a second top plate 5.2, a third top plate 5.3, a fourth top plate 5.4, a first rotating shaft 6.1, a second rotating shaft 6.2, a third rotating shaft 6.3, a fourth rotating shaft 6.4, a first side door 7.1, a second side door 7.2, a third side door 7.3, a fourth side door 7.4, a first support plate 8.1, a second support plate 8.2, a third support plate 8.3, a fourth support plate 8.4, a first air curtain 9.1, a second air curtain 9.2, a third air curtain 9.3, a fourth air curtain 9.4, a first floor 10.1, a second floor 10.2, a third floor 10.3, and a fourth floor 10.4.

The chiller 2 is installed on a middle at a top of a front side of the refrigerated compartment 1; the partition plate 3 which has a length of 2400 mm and a thickness of 80 mm is parallel to the front side of the refrigerated compartment 1; the partition plate 3 divides the refrigerated compartment 1 in half; the first glass plate 4.1 and the second glass plate 4.2 divide the areas separated by the partition plate 3 to form the first floor 10.1, the second floor 10.2, the third floor 10.3, and the fourth floor 10.4; the first glass plate 4.1 and the second glass plate 4.2 are configured as observation windows; the first rotating shaft 6.1 having a diameter of 80 mm is installed at a left side of the refrigerated compartment 1 and 460 mm away from the front side of the refrigerated compartment 1; the second rotating shaft 6.2 having a diameter of 80 mm is installed at a right side of the refrigerated compartment 1 and 460 mm away from the front side of the refrigerated compartment 1; the third rotating shaft 6.3 having a diameter of 80 mm is installed at the left side of the refrigerated compartment 1 and 460 mm away from the partition plate 3; the fourth rotating shaft 6.4 having a diameter of 80 mm is installed at the right side of the refrigerated compartment 1 and 460 mm away from the partition plate 3; the first side door 7.1, the second side door 7.2, the third side door 7.3, and the fourth side door 7.4 each have a length of 2500 mm, and are respectively connected with the first rotating shaft 6.1, the second rotating shaft 6.2, the third rotating shaft 6.3, and the fourth rotating shafts 6.4; the first top plate 5.1, the second top plate 5.2, the third top plate 5.3 and the fourth top plate 5.4 each are a fan-shaped flat plate with a radius of 2400 mm and a central angle of 25°, and are respectively installed on a top of the first side door 7.1, the second side door 7.2, the third side door 7.3 and the fourth side door 7.4; the first air curtain 9.1, the second air curtain 9.2, the third air curtain 9.3, and the fourth air curtain are respectively installed near arcs of the first top plate 5.1, the second top plate 5.2, the third top plate 5.3, and the fourth top plate 5.4; the first support plate 8.1, the second support plate 8.2, the third support 8.3, and the fourth support plate 8.4 each have a width of 2200 mm, and are respectively installed outside the first side door 7.1, the second side door 7.2, the third side door 7.3, and the fourth side door 7.4.

No door is provided at a rear side of the refrigerated compartment 1.

The partition plate 3 is made of aluminum alloy.

The first top plate 5.1, the second top plate 5.2, the third top plate 5.3, the fourth top plate 5.4, the first side door 7.1, the second side door 7.2, the third side door 7.3, the fourth side door 7.4, the first support plate 8.1, the second support plate 8.2, the third support plate 8.3, and the fourth support plate 8.4 are all made of rustproof aluminum alloys to ensure that the device of the present invention has a strong waterproof ability in rainy days.

A rectangular glass plate with a size of 400×500 mm at an upper right corner of the first glass plate 4.1 is cut to ensure the installation of the chiller 2.

The first side door 7.1, the second side door 7.2, the third side door 7.3, and the fourth side door 7.4 each have a maximum rotation angle of 25°.

When the first side door 7.1, the second side door 7.2, the third side door 7.3, and the fourth side door 7.4 are opened, the first air curtain 9.1, the second air curtain 9.2, the third air curtain 9.3, and the fourth air curtain 9.4 work to generate air streams at each entrance to reduce internal cold air loss and external heat intrusion in the refrigerated compartment 1, thereby reducing energy consumption of the chiller 2.

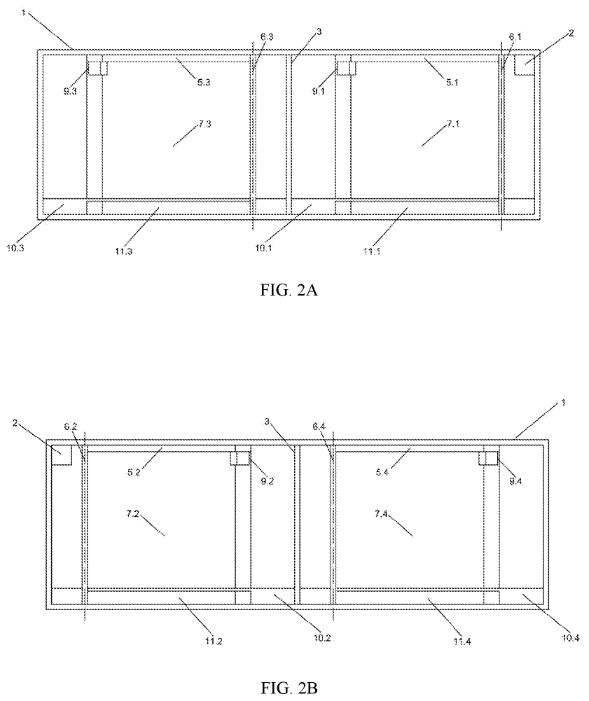

FIGS. 2A and 2B show schematic sectional views of the refrigerated truck with side doors of the present invention. The refrigerated truck includes the refrigerated compartment 1, the chiller 2, the partition plate 3, the first top plate 5.1, the second top plate 5.2, the third top plate 5.3, the fourth top plate 5.4, the first rotating shaft 6.1, the second rotating shaft 6.2, the third rotating shaft 6.3, the fourth rotating shaft 6.4, the first side door 7.1, the second side door 7.2, the third side door 7.3, the fourth side door 7.4, the first air curtain 9.1, the second air curtain 9.2, the third air curtain 9.3, the fourth air curtain 9.4, the first floor 10.1, the second floor 10.2, the third floor 10.3, the fourth floor 10.4, a first base plate 11.1, a second base plate 11.2, a third base plate 11.3 and a fourth base plate 11.4.

The partition plate 3 having a height of 2400 mm divides the refrigerated compartment 1 in half; the first top plate 5.1, the second top plate 5.2, the third top plate 5.3, and the fourth top plate 5.4 each have a thickness of 100 mm, and are respectively installed on tops of the first side door 7.1 and the second side door 7.2, the third side door 7.3 and the fourth side door 7.4; the first base plate 11.1, the second base plate 11.2, the third base plate 11.3 and the fourth base plate 11.4 each have a thickness of 200 mm, and are respectively installed at a bottom of the first side door 7.1, the second side door 7.2, the third side door 7.3 and the fourth side door 7.4; the first base plate 11.1, the second base plate 11.2, the third base plate 11.3 and the fourth base plate 11.4 are respectively housed in the first floor 10.1, the second floor 10.2, the third floor 10.3, and the fourth floor 10.4 when the first side door 7.1, the second side door 7.2, and the third side door 7.3 and the fourth side door 7.4 are closed; the first rotating shaft 6.1, the second rotating shaft 6.2, the third rotating shaft 6.3 and the fourth rotating shaft 6.4 each have a height of 2400 mm.

The first base plate 11.1, the second base plate 11.2, the third base plate 11.3, and the fourth base plate 11.4 are made of Q235 steel, and are twice as thick as the top plates to avoid that excessive stress causes damage during use.

In terms of weight capacity calculation, when the first side door 7.1 is opened, and 2 porters with a weight of 80 kg stand on the first base plate 11.1 and handle goods of a mass of 100 kg, a pressure of 0.32 MPa will be generated. However, the maximum bearing pressure of the Q235 steel is 400 MPa, which is within the allowable range, so the Q235 steel can be used for weight capacity.

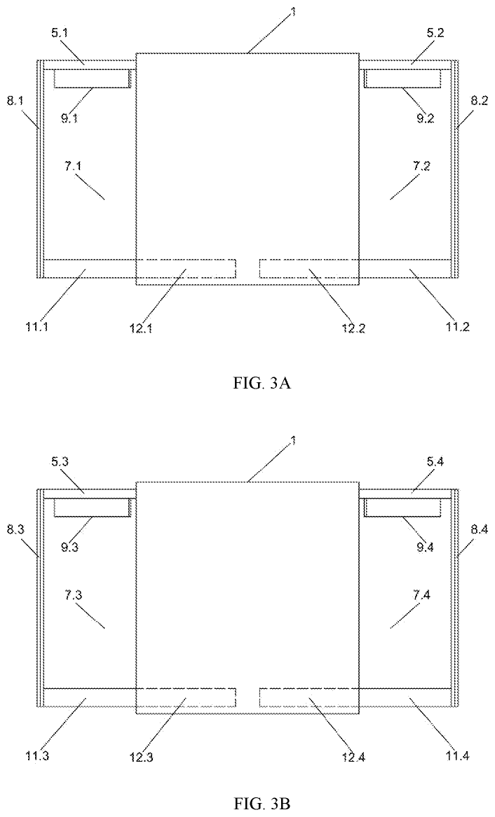

FIGS. 3A-B are left views of the refrigerated truck with side doors of the present invention. The refrigerated truck includes the refrigerated compartment 1, the first top plate 5.1, the second top plate 5.2, the third top plate 5.3, the fourth top plate 5.4, the first side door 7.1, the second side door 7.2, the third side door 7.3, the fourth side door 7.4, the first support plate 8.1, the second support plate 8.2, the third support plate 8.3, the fourth support plate 8.4, the first air curtain 9.1, the second air curtain 9.2, the third air curtain 9.3, the fourth air curtain 9.4, the first base plate 11.1, the second base plate 11.2, the third base plate 11.3 and the fourth base plate 11.4, a first slot 12.1, a second slot 12.2, a third slot 12.3, and a fourth slot 12.4.

The sizes and installation conditions of the first top plate 5.1, the second top plate 5.2, the third top plate 5.3, the fourth top plate 5.4, the first side door 7.1, the second side door 7.2, the third side door 7.3, the fourth side door 7.4, the first support plate 8.1, the second support plate 8.2, the third support plate 8.3, the fourth support plate 8.4, the first air curtain 9.1, the second air curtain 9.2, the third air curtain 9.3 and the fourth air curtain 9.4 are described as above; when the side doors are closed, the first base plate 11.1, the second base plate 11.2, the third base plate 11.3, and the fourth base plate 11.4 are respectively inserted into the first slot 12.1, the second slot 12.2, the third slot 12.3, and the fourth slot 12.4; the first slot 12.1, the second slot 12.2, the third slot 12.3, and the fourth slot 12.4 are respectively arranged in the first floor 10.1, the second floor 10.2, the third floor 10.3, and the fourth floor 10.4.

The first slot 12.1, the second slot 12.2, the third slot 12.3, and the fourth slot 12.4 are fan-shaped and have the same size as the first base plate 11.1, the second base plate 11.2, the third base plate 11.3, and the fourth base plate 11.4, respectively.

When the first side door 7.1, the second side door 7.2, the third side door 7.3 and the fourth side door 7.4 are closed, the first base plate 11.1, the second base plate 11.2, the third base plate 11.3 and the fourth base plate 11.4 are respectively inserted in the first slot 12.1, the second slot 12.2, the third slot 12.3, and the fourth slot 12.4, and are not in contact with goods. The goods are placed on the first floor 10.1, the second floor 10.2, and the third floor 10.3 and the fourth floor 10.4.

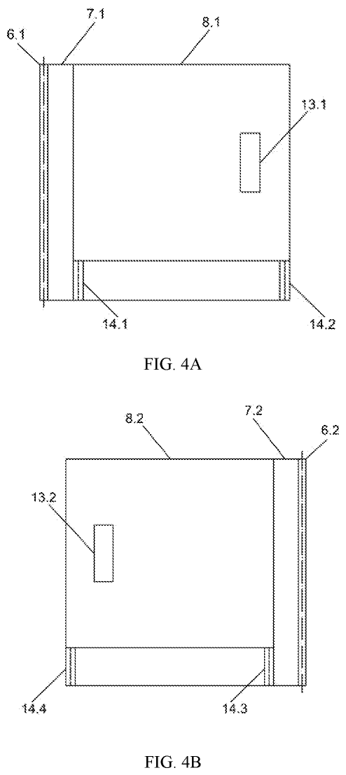

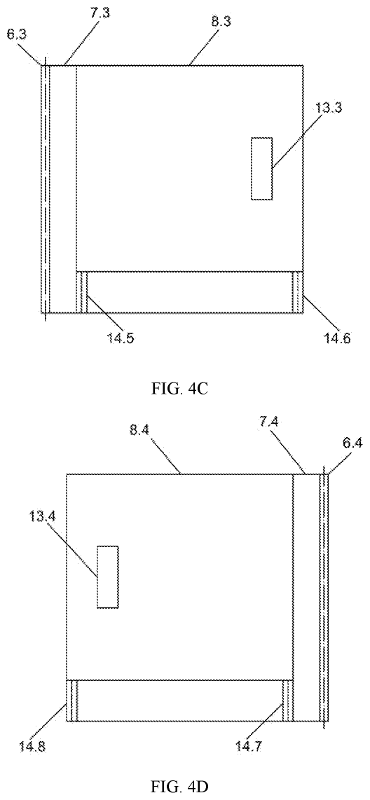

FIGS. 4A-D are schematic diagrams of side doors of the refrigerated truck with side doors of the present invention. The refrigerated truck includes the first rotating shaft 6.1, the second rotating shaft 6.2, the third rotating shaft 6.3, the fourth rotating shaft 6.4, the first side door 7.1, the second side door 7.2, the third side door 7.3, the fourth side door 7.4, the first support plate 8.1, the second support plate 8.2, the third support plate 8.3, the fourth support plate 8.4, a first recessed handle 13.1, a second recessed handle 13.2, a third recessed handle 13.3, a fourth recessed handle 13.4, a first rail 14.1, a second rail 14.2, a third rail 14.3, a fourth rail 14.4, a fifth rail 14.5, a sixth rail 14.6, a seventh rail 14.7, and an eighth rail 14.8.

The first rotating shaft 6.1, the first side door 7.1, the first support plate 8.1, the first recessed handle 13.1, the first rail 14.1 and the second rail 14.2 form a first side door assembly.

The second rotating shaft 6.2, the second side door 7.2, the second support plate 8.2, the second recessed handle 13.2, the third rail 14.3 and the fourth rail 14.4 form a second side door assembly.

The third rotating shaft 6.3, the third side door 7.3, the third support plate 8.3, the third recessed handle 13.3, the fifth rail 14.5 and the sixth rail 14.6 form a third side door assembly.

The fourth rotating shaft 6.4, the fourth side door 7.4, the fourth support plate 8.4, the fourth recessed handle 13.4, the seventh rail 14.7, and the eighth rail 14.8 form a fourth side door assembly.

The first rail 14.1, the second rail 14.2, the third rail 14.3, the fourth rail 14.4, the fifth rail 14.5, the sixth rail 14.6, the seventh rail 14.7, and the eighth rail 14.8 each have a length of 2400 mm and a width of 100 mm; the second rail 14.2 is mounted at a side of the first side door 7.1 which is not connected with the first rotating shaft; the fourth rail 14.4 is mounted at a side of the second side door 7.2 which is not connected with the second rotating shaft; the sixth rail 14.6 is mounted at a side of the third side door 7.3 which is not connected with the third rotating shaft; and the eighth rail 14.8 is mounted at a side of the fourth side door 7.4 which is not connected with the fourth rotating shaft; the first rail 14.1, the third rail 14.3, the fifth rail 14.5, and the seventh rail 14.7 are respectively 260 mm away from the first rotating shaft 6.1, the second rotating shaft 6.2, the third rotating shaft 6.3, and the fourth rotating shaft 6.4; the first support plate 8.1 is mounted on the first rail 14.1 and the second rail 14.2; the second support plate 8.2 is mounted on the third rail 14.3 and the fourth rail 14.4; the third support plate 8.3 is mounted on the fifth rail 14.5 and the sixth rail 14.6; the fourth support plate 8.4 is mounted on the seventh rail 14.7 and the eighth rail 14.8; the first recessed handle 13.1, the second recessed handle 13.2, the third recessed handle 13.3, and the fourth recessed handle 13.4 each have a size of 200×600 mm, and are respectively installed on the first support plate 8.1, the second support plate 8.2, the third support plate 8.3, and the fourth support plate 8.4; the first recessed handle 13.1, the second recessed handle 13.2, the third recessed handle 13.3, and the fourth recessed handle 13.4 are respectively 700 mm away from a top of corresponding support plates and 300 mm away from the sides of the corresponding support plates which are not connected with corresponding rotating shafts.

The first recessed handle 13.1, the second recessed handle 13.2, the third recessed handle 13.3, and the fourth recessed handle 13.4 are configured as pulling positions for opening and closing the side doors and sliding the support plates.

A magnet is respectively installed on a top of the first rail 14.1, the second rail 14.2, the third rail 14.3, the fourth rail 14.4, the fifth rail 14.5, the sixth rail 14.6, the seventh rail 14.7, and the eighth rail 14.8, where a side of the magnet facing the support plate is an N-pole.

Two magnets are respectively installed on a top of the first support plate 8.1, the second support plate 8.2, the third support plate 8.3, the fourth support plate 8.4, where a side of the magnet facing the rail is an S-pole.

When the side doors are closed, the support plates slide upward along the rails and are fixed by the magnet.

When the side doors are opened, the support plates slide downward along the rails until the support plates contact the ground, so as to act as the auxiliary weight capacity.

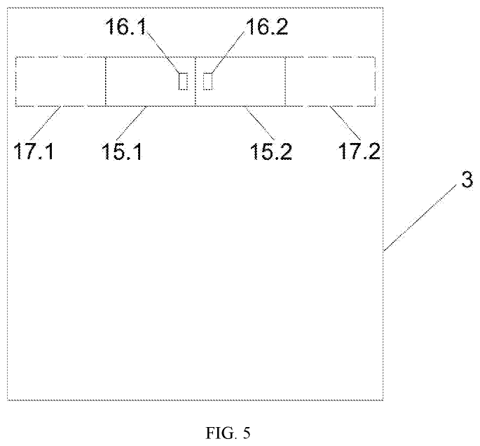

FIG. 5 is a schematic diagram of the partition plate 3 of the refrigerated truck with side doors according to an embodiment of the present invention. The partition plate includes a first moveable window 15.1, a second moveable window 15.2, a first moving handle 16.1, a second moving handle 16.2, a first groove 17.1, and a second groove 17.2.

The first moveable window 15.1 and the second moveable window 15.2 each have a size of 550×300 mm, and a top thereof is 300 mm away from the top of the partition plate 3; the first moving handle 16.1 and the second moving handle 16.2 are respectively mounted on the first moveable window 15.1 and the second moveable window 15.2; the first groove 17.1 and the second groove 17.2 which are 1100×300 mm in size are connected with each other, and a top thereof is 300 mm away from the top of the partition plate 3.

The partition plate 3, the first moveable window 15.1, the second moveable window 15.2, the first moving handle 16.1 and the second moving handle 16.2 are all made of aluminum alloy.

The first moving handle 16.1 and the second moving handle 16.2 are respectively configured to control translations of the first moveable window 15.1 and the second moveable window 15.2, so that opening areas of the first groove 17.1 and the second groove 17.2 can be adjusted, so the amount of cold air passing in can be adjusted.

An outer half of the first groove 17.1 is hidden inside the partition plate 3, and an outer half of the second groove 17.2 is also hidden inside the partition plate 3.

The refrigerated truck with side doors of other sizes can be designed based on the overall layout of the present invention, for example, the number of side doors and partition plates of the refrigerated compartment can be increased or decreased according to an actual size of the refrigerated truck, the overall layout is similar to the the present invention.

The above-mentioned embodiment is only intended to illustrate the principle and uses of the present invention, and its description is more specific and detailed, but it cannot be understood as limiting the scope of the patent of the present disclosure. It should be pointed out those of ordinary skill in the art may further make a plurality of variations and improvements without departing from the concept of the present invention, and these all pertain to the protection scope of the present invention.

What is claimed is:

1. A refrigerated truck with side doors, comprising: a refrigerated compartment, a chiller, a partition plate, a plurality of glass plates, a plurality of top plates, a plurality of rotating shafts, a plurality of side doors, a plurality of support plates, a plurality of air curtains, a plurality of floors, a plurality of base plates, a plurality of slots, a plurality of recessed handles, a plurality of rails, a plurality of moveable windows, a plurality of moving handles and a plurality of grooves;
wherein the plurality of glass plates comprise a first glass plate and a second glass plate;
the plurality of top plates comprise a first top plate, a second top plate, a third top plate, and a fourth top plate;
the plurality of rotating shafts comprise a first rotating shaft, a second rotating shaft, a third rotating shaft, and a fourth rotating shaft;
the plurality of side doors comprise a first side door, a second side door, a third side door, and a fourth side door;
the plurality of support plates comprise a first support plate, a second support plate, a third support plate, and a fourth support plate;
the plurality of air curtains comprise a first air curtain, a second curtain machine, a third air curtain, and a fourth air curtain;
the plurality of floors comprise a first floor, a second floor, a third floor, and a fourth floor;
the plurality of base plates comprise a first base plate, a second base plate, a third base plate, and a fourth base plate;
the plurality of slots comprise a first slot, a second slot, a third slot, and a fourth slot;
the plurality of recessed handles comprise a first recessed handle, a second recessed handle, a third recessed handle, and a fourth recessed handle;
the plurality of rails comprise a first rail, a second rail, a third rail, a fourth rail, a fifth rail, a sixth rail, a seventh rail, and an eighth rail;
the plurality of moveable windows comprise a first moveable window and a second moveable window;
the plurality of moving handles comprise a first moving handle and a second moving handle;
the plurality of grooves comprise a first groove and a second groove;
the first rotating shaft, the first side door, the first support plate, the first recessed handle, the first rail, and the second rail form a first side door assembly; the second rotating shaft, the second side door, the second support plate, the second recessed handle, the third rail, and the fourth rail form a second side door assembly; the third rotating shaft, the third side door, the third support plate, the third recessed handle, the fifth rail, and the sixth rail form a third side door assembly; the fourth rotating shaft, the fourth side door, the fourth support plate, the fourth recessed handle, the seventh rail, and the eighth rail form a fourth side door assembly;
the chiller is installed on a middle at a top of a front side of the refrigerated compartment;
the refrigerated compartment is divided into 4 cold storage areas of the same size by the partition plate, the first glass plate and the second glass plate;
the side doors are respectively installed on two sides of the refrigerated compartment;
the top plates and the base plates are fan-shaped and connected to the side doors;
the top plates are respectively installed on a top of the side doors, and the base plates are installed on a bottom of the side doors;
the air curtains are installed on a middle of the top plates, respectively;
the side doors and the refrigerated compartment are connected via the rotating shafts;
the support plates are respectively installed outside the side doors, and slide up and down through the rails installed outside the side doors; when in use, the support plates slide down to support the side doors; when not in use, the support plates slide up and is retracted;
the recessed handles are installed on the support plates; when the support plates are retracted, the recessed handles assist the opening and closing of the side doors; when the support plates are used to support the side doors, the recessed handles assist the sliding of the support plates;
the slots are installed in the floors of the refrigerated compartment for the arrangement of the base plates when the side doors are closed;
the moveable windows are installed on the partition plate;
the grooves are arranged beside the moveable windows; and
the moving handles are installed on the moveable windows to control the movement of the moveable windows.

2. The refrigerated truck of claim 1, wherein no door is provided at a rear side of the refrigerator compartment.

3. The refrigerated truck of claim 1, wherein the partition plate, the moveable windows and the moving handles are made of aluminum alloy.

4. The refrigerated truck of claim 1, wherein the side doors, the top plates and the support plates are made of rustproof aluminum alloy.

5. The refrigerated truck of claim 4, wherein a maximum opening angle of the side doors is 25°˜30°.

6. The refrigerated truck of claim 4, wherein a height of each of the support plates is 70%˜90% of a height of each of the side doors.

7. The refrigerated truck of claim 1, wherein the base plates are made of Q235 steel.

8. The refrigerated truck of claim 1, wherein a magnet is installed on a top of each of the rails, and a side of the magnet facing the support plate is N-pole.

9. The refrigerated truck of claim 1, wherein a magnet is installed at a top of each of the support plates, and a side of the magnet facing the rails is S-pole; and the magnet is embedded in the support plate and has the same width as the support plate.
